(19) United States
(12) Patent Application Publication
(10) Pub. No.: US 2026/0208948 A1
(43) Pub. Date: Jul. 23, 2026

(54) CONTAINER HANDLING VEHICLE FOR HANDLING OF SMALLER-SIZED STORAGE CONTAINERS IN AN AUTOMATED STORAGE AND RETRIEVAL SYSTEM

(71) Applicant: AutoStore Technology AS, Nedre Vats (NO)

(72) Inventor: Jørgen Djuve Heggebø, Langhus (NO)

(21) Appl. No.: 19/138,817

(22) PCT Filed: Dec. 18, 2023
(86) PCT No.: PCT/EP2023/086415

§ 371 Date: Jun. 13, 2025

(30) Foreign Application Priority Data
Dec. 19, 2022 (NO) 20221359

(51) Int. Cl. B65G 1/04; B65G 1/06; B66D 1/20

(52) U.S. Cl. CPC B65G 1/0464; B65G 1/065; B66D 1/20

(57) ABSTRACT

The present invention relates to a container handling vehicle (10) for an automated storage and retrieval system (1), wherein the container handling vehicle (10) comprises a vehicle body (11) a first gripping section (20a) for engaging a first edge (6e1; 106e1) of a storage container (6; 106) and a first lifting section (30a) for 5 lifting the first gripping section (20a) relative to the vehicle body (11). The vehicle further comprises a second gripping section (20b) for engaging a second edge (6e2; 106e2) of the storage container (6; 106) and a second lifting section (30b) for lifting the second gripping section (20b) relative to the vehicle body (11). The first lifting section (30a) and the second lifting section (30b) are configured to keep the first 10 gripping section (20a) and the second gripping section (20b) horizontally aligned with each other. The first actuator (41) for adjusting a horizontal position of the first gripping section (20a) relative to the vehicle body (11).

Container handling vehicle for handling of smaller-sized storage containers in an automated storage and retrieval system.

### FIELD OF THE INVENTION

The present invention relates to a container handling vehicle for an automated storage and retrieval system. The present invention also relates to an automated storage and retrieval system comprising a framework structure.

### BACKGROUND AND PRIOR ART

FIG. 1 discloses a prior art automated storage and retrieval system 1 with a framework structure 100 and FIGS. 2, 3 and 4 disclose three different prior art container handling vehicles 201,301,401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supporting.

Each prior art container handling vehicle 201,301,401 comprises a vehicle body 201a,301a,401a and first and second sets of wheels 201b, 201c, 301 b, 301c,401b,401c which enable the lateral movement of the container handling vehicles 201,301,401 in the X direction and in the Y direction, respectively. In FIGS. 2, 3 and 4 two wheels in each set are fully visible. The first set of wheels 201b,301b,401b is arranged to engage with two adjacent rails of the first set 110 of rails, and the second set of wheels 201c,301c,401c is arranged to engage with two adjacent rails of the second set 111 of rails. At least one of the sets of wheels 201b, 201c, 301b,301c,401b,401c can be lifted and lowered, so that the first set of wheels 201b,301b,401b and/or the second set of wheels 201c,301c,401c can be engaged with the respective set of rails 110, 111 at any one time.

Each prior art container handling vehicle 201,301,401 also comprises a lifting device for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201,301,401 so that the position of the gripping/engaging devices with respect to the vehicle 201,301,401 can be adjusted in a third direction Z which is orthogonal the first direction X and the second direction Y. Parts of the gripper device of the container handling vehicles 301,401 are shown in FIGS. 3 and 4 indicated with reference number 304,404. The gripper device of the container handling device 201 is located within the vehicle body 201a in FIG. 2 and is thus not shown.

Conventionally, and also for the purpose of this application, Z=1 identifies the uppermost layer available for storage containers below the rails 110,111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′in FIG. 1 can be said to occupy storage position X=17, Y=1, Z=6. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X-and Y-direction, while each storage cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a, 401a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicle 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail 110,111 may comprise two parallel tracks. In other rail systems 108, each rail in one direction (e.g. an X direction) may comprise one track and each rail in the other, perpendicular direction (e.g. a Y direction) may comprise two tracks. Each rail 110,111 may also comprise two track members that are fastened together, each track member providing one of a pair of tracks provided by each rail.

WO2018/146304A1, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301,401 can drop off storage containers 106 to be transported to an access or a transfer station, and the second port column 120 may be a dedicated pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119,120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301,401 to a location above the storage column 105 in which the target storage container 106 is positioned, retrieving the storage container 106 from the storage column 105 using the container handling vehicle's 201,301,401 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105, or relocated to other storage columns 105.

For monitoring and controlling the automated storage and retrieval system 1, e.g. monitoring and controlling the location of respective storage containers 106 within the framework structure 100, the content of each storage container 106, and the movement of the container handling vehicles 201,301,401 so that a desired storage container 106 can be delivered to the desired location at the desired time without the container handling vehicles 201,301,401 colliding with each other, the automated storage and retrieval system 1 comprises a control system 500 which typically is computerized and which typically comprises a database for keeping track of the storage containers 106.

WO 2019/101366 describes a container handling vehicle capable of lifting two or four storage containers of the same size individually or simultaneously.

WO 2017/178370 describes a container handling vehicle for lifting smaller-sized storage containers.

WO2017211634 shows a gripper device of a container handling vehicle which can be operated to lift a desired smaller-sized bin from a group of smaller-sized bins adjacent to each other.

One object of the invention is to provide an alternative container handling vehicle to the above.

### SUMMARY OF THE INVENTION

The present invention relates to a container handling vehicle for an automated storage and retrieval system, wherein the container handling vehicle comprises:
a vehicle body;
a first gripping section for engaging a first edge of a storage container;
a first lifting section for lifting the first gripping section relative to the vehicle body;
a second gripping section for engaging a second edge of the storage container;
a second lifting section for lifting the second gripping section relative to the vehicle body;
   wherein the first lifting section and the second lifting section are configured to keep the first gripping section and the second gripping section horizontally aligned with each other; and
a first actuator for adjusting a horizontal position of the first gripping section and/or the second gripping section relative to the vehicle body.

In one aspect, the first actuator is adjusting the horizontal position of the first gripping section relative to the vehicle body by adjusting the horizontal position of the first lifting section relative to the vehicle body.

In one aspect, the first actuator is adjusting the horizontal position of the first gripping section relative to the second gripping section and relative to the vehicle body.

In one aspect, the first gripping section and the second gripping section are secured to each other, and wherein the first actuator is arranged to adjust a horizontal position of the first gripping section and the second gripping section.

In one aspect, the container handling vehicle comprises:
a second actuator for adjusting a horizontal position of the second gripping section relative to the first gripping section.

In one aspect, the second actuator is adjusting the horizontal position of the second gripping section relative to the vehicle body by adjusting the horizontal position of the second lifting section relative to the vehicle body.

In one aspect, the container handling vehicle is configured to be in one of the following states:
a first state, in which the position of the first gripping section is a first distance from the position of the second gripping section for the purpose of engaging a first storage container;
a second state, in which the position of the first gripping section is a second distance from the position of the second gripping section for the purpose of engaging a second storage container, wherein the second distance is smaller than the first distance.

In one aspect, the first storage container is larger than the second storage container.

In one aspect, the second distance is 40%-50% of the first distance.

In one aspect, the first actuator and the second actuator are configured to move the second storage container horizontally relative to the vehicle body when in the second state.

In one aspect, the first actuator and the second actuator are configured to move the second storage container a third distance being equal to, or larger than, the second distance relative to the vehicle body when in the second state.

According to the above, the second storage container can be lifted up from one smaller-sized storage column and lowered into an adjacent smaller-sized storage column without moving the container handling vehicle.

In one aspect, the first gripping section is configured to engage a first edge of the first storage container and a first edge of the second storage container and wherein the second gripping section is configured to engage a second edge of the first storage container and a second edge of the second storage container.

In one aspect, the first edge of the first storage container is identical to the first edge of the second storage container. In one aspect, the second edge of the first storage container is identical to the second edge of the second storage container.

In one aspect, the first edges of the first and second storage containers comprises a gripper interface and a guide pin interface. In one aspect, the second edges of the first and second storage containers also comprises a gripper interface and a guide pin interface.

In one aspect, the first storage container has a width being equal to a width of the second storage container and a length being equal to or less than 50% of a length of the second storage container.

According to the above, as the first gripping section may engage the first edge of both types of storage containers and the second gripping section may engage the second edge of both types of storage containers, the same two gripping sections may be used to engage storage containers of different sizes just by adjusting the horizontal position between the first gripping section and the second gripping section.

Hence, one type of container handling vehicle can handle prior art first storage containers and smaller-sized second storage containers.

In one aspect, the container handling vehicle comprises a rotatable shaft;
the first lifting section comprising a belt drum connected to the shaft and a lifting belt connected between the belt drum and the first gripping section;
the second lifting section comprising a belt drum connected to the shaft or a further shaft and a lifting belt connected between the belt drum and the second gripping section;
   wherein the first actuator is arranged to adjust the horizontal position of the first gripping section by adjusting the horizontal position of the belt drum of the first lifting section on the shaft.

The lifting belt may be a belt, a webbing, a wire, etc.

In one aspect, the shaft is a splined shaft, allowing the belt drums to be axially displaced relative to the splined shaft while allowing the belt drums to be rotated by the same splined shaft.

In one aspect, the second actuator is arranged to adjust the horizontal position of the second gripping section relative to the first gripping section by adjusting a horizontal position of the belt drum of the second lifting section relative to the belt drum of the first lifting section on the shaft or on the further shaft.

By rotation of the rotatable shaft and the further shaft, the lifting belts will be either be reeled onto or reeled out from the belt drums, causing the first and second gripping sections to be lifted or lowered respectively.

In one aspect, the first gripping section comprises a frame, at least two guide pins secured to the frame, and a gripper secured to the frame; and the second gripping section comprises a frame, at least two guide pins secured to the frame, and a gripper secured to the frame.

The frames of the first gripping section and the second gripping section may be connected by a spacer device configured to allow selective adjustment of the distance between the frames and to maintain said distance when not undergoing adjustment, e.g. the distance may be adjusted only when the lifting belts are reeled completely onto the belt drums such that the gripping sections are in their uppermost position, and otherwise the distance is maintained. The distance between the frames is preferably adjusted according to the distance between the belt drums adjusted by the first and/or the second actuator. The spacer device may e.g. be a third actuator or an adjustable spacer.

In one aspect, the first gripping section comprises a frame, at least two guide pins secured to the frame and a gripper secured to the frame;
the second gripping section comprises a frame, at least two guide pins secured to the frame and a gripper secured to the frame;
the container handling vehicle comprises a third actuator for adjusting the horizontal distance between the frame of the first gripping section and the frame of the second gripping section.

In one aspect, the first gripping section comprises a frame, at least two guide pins secured to the frame and a gripper secured to the frame;
the second gripping section comprises a frame, at least two guide pins secured to the frame and a gripper secured to the frame;
the frame of the first gripping section and the frame of the second gripping section may be connected by an adjustable spacer, wherein the adjustable spacer is configured to be in a locked state and in an unlocked state, wherein when in the unlocked state, the spacer allows for adjusting a horizontal position of the frame of the second gripping section relative to the frame of the first gripping section, and when in the locked state, the spacer is configured to maintain a horizontal position of the frame of the second gripping section relative to the frame of the first gripping section.

In one aspect, the guide pins secured to the frame are extending vertically. In one aspect, the guide pins secured to the frame are extending above and below the frame. In one aspect, the guide pins are provided to match an aperture between the upright members of the framework structure and a recess in each corner of the storage containers.

In one aspect, the container handling vehicle comprises a control system for controlling the first actuator, the second actuator and/or the third actuator.

In one aspect, the control system is configured to control the first actuator, the second actuator and the third actuator to keep a distance between the position of the first gripping section and the position of the second gripping section proportional to the distance between the belt drum of the first lifting section and the belt drum of the second lifting section.

In one aspect, the control system is configured to control the first actuator, the second actuator and/or the third actuator based on information received from a control system of the automated storage and retrieval system.

In one aspect, the control system is configured to control lifting and lowering of the first and second gripping sections, e.g. by controlling rotation of the rotatable shaft(s).

The present invention also relates to an automated storage and retrieval system comprising a framework structure, wherein the framework structure comprises:
upright members;
a first storage volume comprising first storage columns provided between the upright members, wherein first storage containers are stackable in first stacks within the first storage columns;
a second storage volume comprising second storage columns provided between the upright members, wherein second storage containers are stackable in second stacks within the second storage columns; and
a rail system provided on top of the upright members,
   wherein the automated storage and retrieval system comprises a container handling vehicle arranged to operate on the rail system; characterized in that the container handling vehicle is a container handling vehicle according to the above, wherein the container handling vehicle is configured to handle the second storage containers.

In one aspect, the container handling vehicle is configured to handle only the second storage containers. Here, a different type of container handling vehicle is used to handle the first type of storage containers.

In one aspect, the second storage columns are formed by separating one of the first storage columns into two or more storage columns.

In one aspect, the second storage columns are smaller than the first storage columns.

In one aspect, the framework structure comprises a separation element for separating the first storage column into two or more second storage columns.

In one aspect, the separation element is a separation wall.

In one aspect, the container handling vehicle is a container handling vehicle according to the above, wherein the container handling vehicle is arranged to handle the first storage containers and the second storage containers by adjusting the horizontal position of the second gripping section relative to the first gripping section.

### BRIEF DESCRIPTION OF THE DRAWINGS

Following drawings are appended to facilitate the understanding of the invention. The drawings show embodiments of the invention, which will now be described by way of example only, where:

FIG. 1 is a perspective view of a framework structure of a prior art automated storage and retrieval system.

FIG. 2 is a perspective view of a prior art container handling vehicle having an internally arranged cavity for carrying storage containers therein.

FIG. 3a is a perspective view of a prior art container handling vehicle having a cantilever for carrying storage containers underneath.

FIG. 3b is a perspective view of the prior art container handling vehicle in FIG. 3a, where the top cover has been removed to show the lifting device more easily.

FIG. 3c is a perspective view from below of the prior art container handling vehicle in FIG. 3b, where details of the lifting device and gripper device are shown in detail.

FIG. 4 is a perspective view, seen from below, of a prior art container handling vehicle having an internally arranged cavity for carrying storage containers therein.

FIG. 5a illustrates schematically a top view of the prior art storage container.

FIG. 5b illustrates schematically a top view of two smaller-sized storage containers.

FIG. 6 illustrates a perspective view of a first embodiment of the automated storage and retrieval system.

FIG. 7 illustrates a side View of FIG. 6.

FIG. 8a-c illustrate schematically a side view of the gripping sections and lifting sections of a first embodiment of the container handling vehicle.

FIG. 9a-d illustrate schematically a side view of the first embodiment of the container handling vehicle where the cantilever structure is drawn partially transparent with a dashed outline.

FIG. 10a-c illustrate schematically a side view of a second embodiment of the container handling vehicle.

FIG. 11 illustrates schematically the gripping sections and lifting sections implemented in the container handling vehicle type of FIG. 2 or FIG. 4.

FIG. 12 illustrates schematically a fourth embodiment of the container handling vehicle holding a smaller-sized second storage container.

FIG. 13 shows the gripping sections and lifting sections of the embodiment of FIG. 12.

FIG. 14 shows the gripping sections and lifting sections of the embodiment of FIG. 12, where the belt drum housing and connecting members are removed to show further details of the lifting arrangement.

FIG. 15 illustrates schematically the fourth embodiment of the container handling vehicle holding a prior art storage container, wherein the vehicle body is removed to better show the interior.

FIG. 16 is a top view of the container handling vehicle shown in FIG. 15, wherein the vehicle body is removed to better show the interior.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

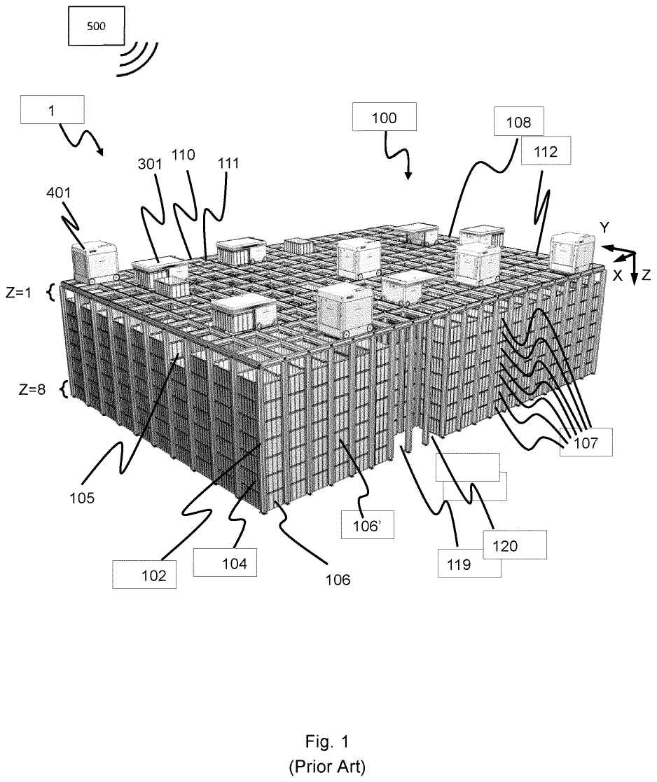

The framework structure 100 of the automated storage and retrieval system 1 is constructed in a similar manner to the prior art framework structure 100 described above in connection with FIGS. 1-3. That is, the framework structure 100 comprises a number of upright members 102, and comprises a rail system 108 extending in the X direction and Y direction on top of the upright members 102.

The framework structure 100 further comprises storage compartments in the form of storage columns 105 provided between the members 102 wherein storage containers 106 are stackable in stacks 107 within the storage columns 105.

The framework structure 100 can be of any size. In particular it is understood that the framework structure can be considerably wider and/or longer and/or deeper than disclosed in FIG. 1. For example, the framework structure 100 may have a horizontal extent of more than 700×700 columns and a storage depth of more than twelve containers.

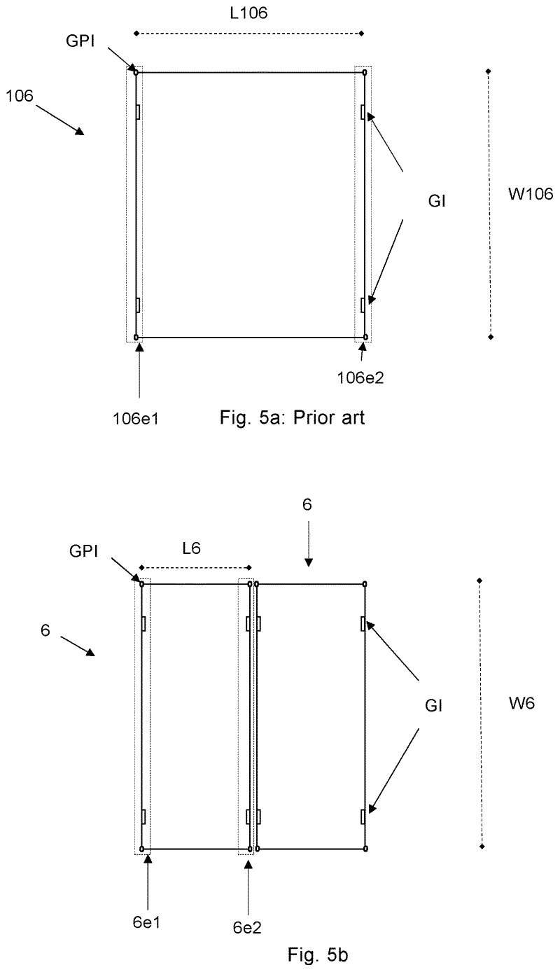

It is now referred to FIG. 5a, wherein a prior art storage container 106 is shown. The storage container 106 is shown with two edges 106e1 and 106e2, wherein each edge has a gripper interface GI (indicated as a rectangular opening in the top edge of the storage container) and a guide pin interface GPI (indicated as a circular recess or opening in the top edge of the storage container).

As is known, the purpose of the gripper interface GI is to allow a gripper 304b, 404b of the container handling vehicle to engage the storage container to lift the storage container. The purpose of the guide pin interface GPI is to guide the gripper in relation to the upright members 102 during the movement of the gripper up and down in the storage columns and further to position the gripper correctly in relation to the storage container 106.

It is now referred to FIG. 5b. Here, a second type of storage container 6 is shown. FIG. 5b shows two such second storage containers 6 adjacent to each other, for comparison with FIG. 5a. As indicated, a width W106 of the first storage container 106 is equal to a width W6 of the second storage containers 6 and a length L106 of the first storage container 106 is ca 2 times a length L6 of the second storage container. Hence, the second storage containers 6 may be referred to as smaller-sized storage containers, wherein two such smaller-sized storage containers 6 have approximately the same footprint as one first storage container 106.

Similar to the first storage container 106, also the second storage container 6 has two edges 6e1 and 6e2, wherein each edge has a gripper interface GI (indicated as a rectangular opening in the top edge of the storage container) and a guide pin interface GPI (indicated as a circular recess or opening in the top edge of the storage container).

Preferably, the first edge 6e1 of the second storage container 6 is identical to the first edge 106e1 of the first storage container 106 and the second edge 6e2 of the second storage container 6 is identical to the second edge 106e2 of the first storage container 106.

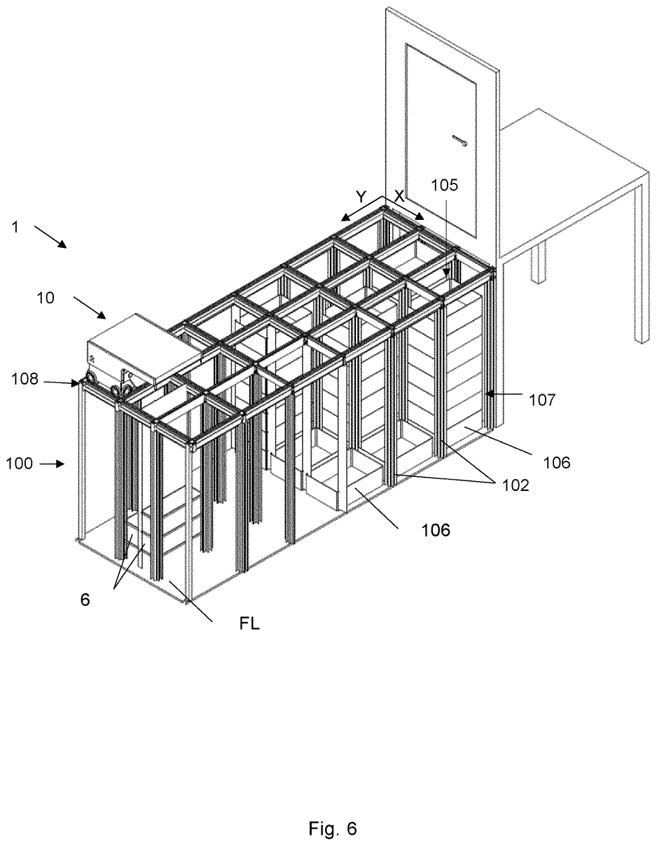

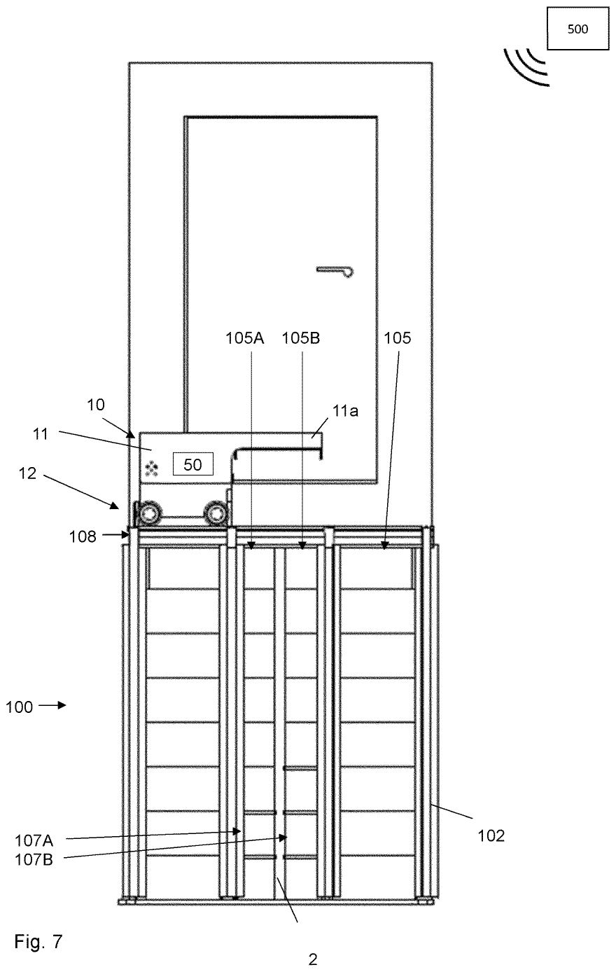

An embodiment of the automated storage and retrieval system according to the invention will now be discussed in more detail with reference to FIGS. 6 and 7. The prior art storage volume is hereinafter referred to as a first storage volume comprising first storage columns 105 provided between the upright members 102, wherein the prior art first storage containers 106 are stackable in first stacks 107 within the first storage columns 105.

The framework structure 100 further comprises a second storage volume comprising second storage columns 105A, 105B provided between the upright members 102, wherein the second storage containers 6 are stackable in second stacks 107A, 107B within the second storage columns 105A, 105B.

In FIGS. 6 and 7 it is shown that the second storage columns 105A, 105B are formed by separating one of the first storage columns 105 into two or more storage columns by means of a separation element 2 in the form of a vertical separation wall. The separation element 2 may be located between two upright members 102 and connected between the floor FL and the rail system 108.

The system 1 further comprises a container handling vehicle 10 arranged to operate on the rail system 108. The container handling device 10 will now be described in detail. It should be noted that in many of the embodiments below, the container handling vehicle 10 is a cantilever type of vehicle, i.e. the vehicle 10 comprises a body 11 and a cantilever structure 11a protruding horizontally from the body 11.

### The Container Handling Device 10—First Embodiment

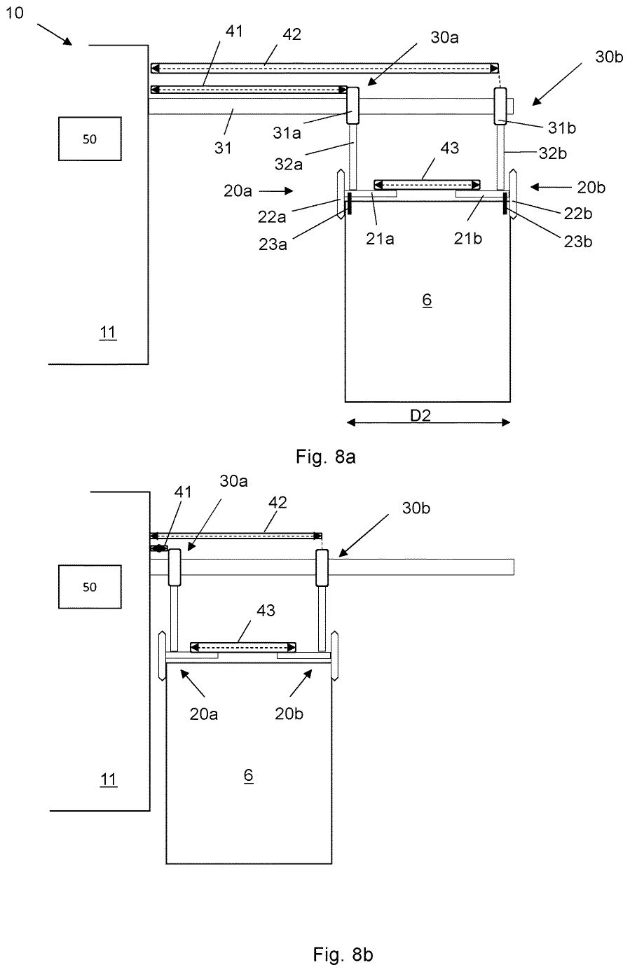

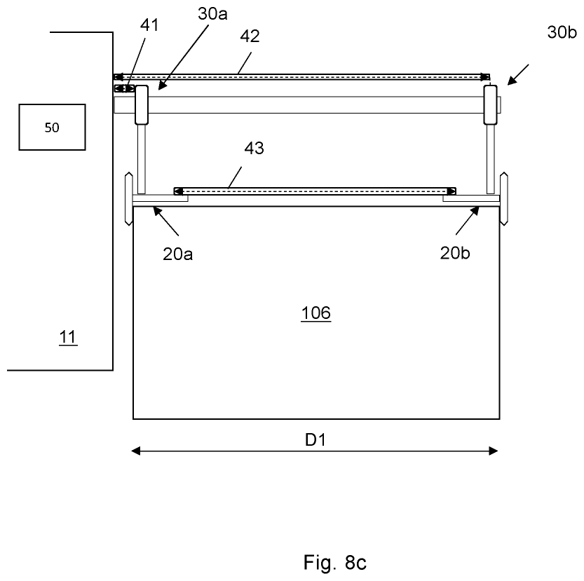

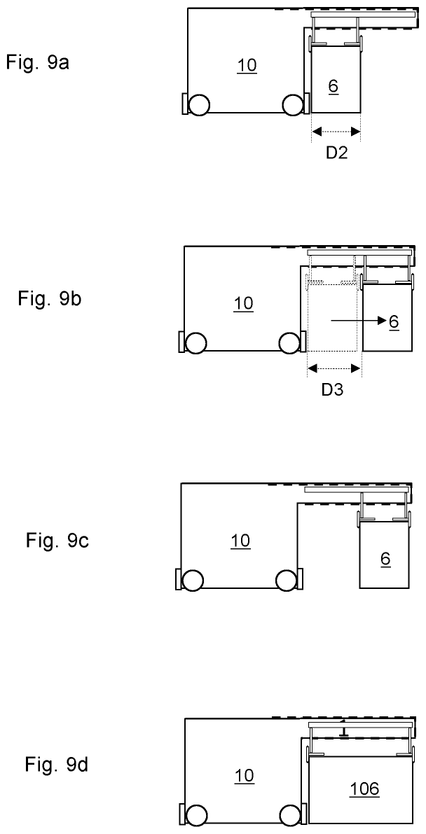

It is now referred to FIG. 8a-c and FIG. 9a-d. Here, the vehicle body 11 of the container handling vehicle 10 is indicated with a solid line on the left side of the drawings, while parts located within the cantilever structure 11a is shown protruding from the right side of the vehicle body 11.

The vehicle 10 comprises a first gripping section 20a and a second gripping section 20b. The first gripping section 20a comprises a frame 21a, at least two guide pins 22a secured to the frame 21a and a gripper 23a secured to the frame 21a. The second gripping section 20b comprises a frame 21b, at least two guide pins 22b secured to the frame 21b and a gripper 23b secured to the frame 21b.

In addition, the vehicle 10 comprises a first lifting section 30a for lifting the first gripping section 20a relative to the vehicle body 11 and a second lifting section 30b for lifting the second gripping section 20b relative to the vehicle body 11.

The vehicle 10 comprises a rotatable shaft 31. The first lifting section 30a comprising a belt drum 31a connected to the shaft 31 and a lifting belt 32a connected between the belt drum 31a and the first gripping section 20a. Similarly, the second lifting section 30b comprising a belt drum 31b connected to the shaft 31 or to a further shaft and a lifting belt 32b connected between the belt drum 31b and the second gripping section 20b.

By rotation of the rotatable shaft 31 (and possibly also the further shaft), the lifting belts 32a, 32b will be either be reeled onto or reeled out from the belt drums 31a, 31b, causing the first and second gripping sections 20a, 20b to be lifted or lowered respectively.

The vehicle 10 here comprises three actuators. A first actuator 41 is arranged to adjust the horizontal position of the first gripping section 20a by adjusting the horizontal position of the belt drum 31a of the first lifting section 30a on the shaft 31. In this way, the first actuator 41 is adjusting the horizontal position of the first gripping section 20a relative to the vehicle body 11.

A second actuator 42 is arranged to adjust a horizontal position of the second gripping section 20b by adjusting the horizontal position of the belt drum 31b of the second lifting section 30b on the shaft 31. In this way, the second actuator 42 is adjusting the horizontal position of the second gripping section 20b relative to the vehicle body 11.

In the present embodiment, the shaft is a splined shaft, allowing the belt drums to be axially displaced relative to the splined shaft while allowing the belt drums to be rotated by the same splined shaft.

A third actuator 43 is arranged to adjust a horizontal distance between the frame 21a of the first gripping section 20a and the frame 21b of the second gripping section 20b. Hence, by adjusting the distance between the frame 21a of the first gripping section 20a and the frame 21b of the second gripping section 20b, the container handling vehicle 10 can be configured to be in one of the following states:
a first state, in which the position of the first gripping section 20a is a first distance D1 from the position of the second gripping section 20b for the purpose of engaging a first storage container 106 (see FIG. 8a).
a second state, in which the position of the first gripping section 20a is a second distance D2 from the position of the second gripping section 20b for the purpose of engaging a second storage container 6, wherein the second distance D2 is smaller than the first distance D1 (see FIG. 8c and FIG. 9a).

In addition, the first actuator 41 and the second actuator 42 can be configured to move the second storage container 6 a third distance D3 (FIG. 9b) being equal to, or larger than, the second distance D2 relative to the vehicle body 11 when in the second state. In this way, the second storage container 6 can be lifted up from one smaller-sized storage column 105A and lowered into an adjacent smaller-sized storage column 105B without moving the container handling vehicle 10. This is illustrated in FIGS. 8a and 8b, and FIG. 9a-c.

### The Container Handling Device 10—Second Embodiment

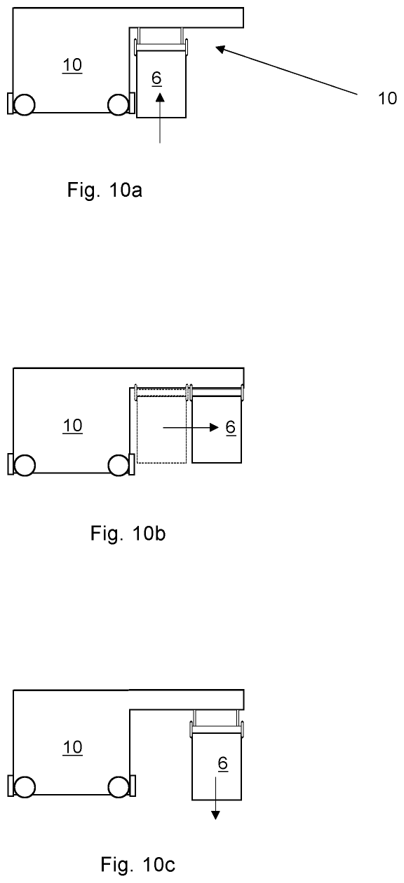

It is now referred to FIG. 10a-c. Here, the first gripping section 20a and the second gripping section 20b are secured to each other, i.e. there are no third actuator 43.

This vehicle 10 comprises only a first actuator 41, which is arranged to adjust a horizontal position of the first gripping section 20a and the second gripping section 20b relative to the vehicle body. In this embodiment, the container handling vehicle 10 is configured to handle only the second storage containers 6. Hence, a different type of container handling vehicle is required to handle the first type of storage containers 106.

In a first position shown in FIG. 10a, the second storage container 6 can be lifted up from and down into the smaller-sized storage column 105A. By horizontal movement of the first gripping section 20a and the second gripping section 20b as illustrated in FIG. 10b, the position shown in FIG. 10c is achieved. In this second position shown in FIG. 10c, the second storage container 6 can be lifted up from and down into the smaller-sized storage column 105B.

### The Container Handling Device 10—Third Embodiment

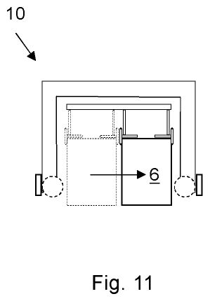

It is now referred to FIG. 11, where it is shown that the first and second embodiments described above can be implemented also in a container handling vehicle type of FIG. 2 or FIG. 4.

### The Container Handling Device 10—Fourth Embodiment

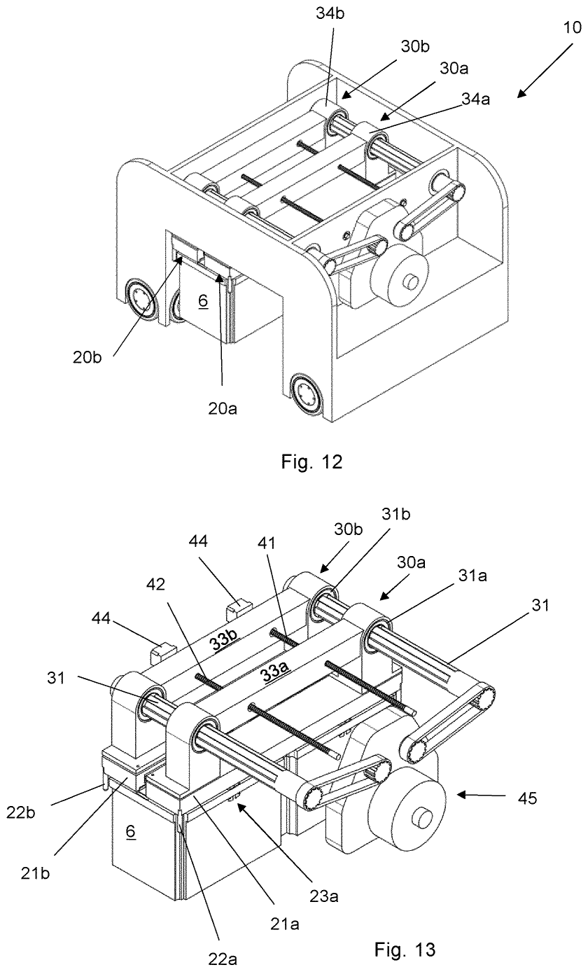

It is now referred to FIGS. 12 to 15.

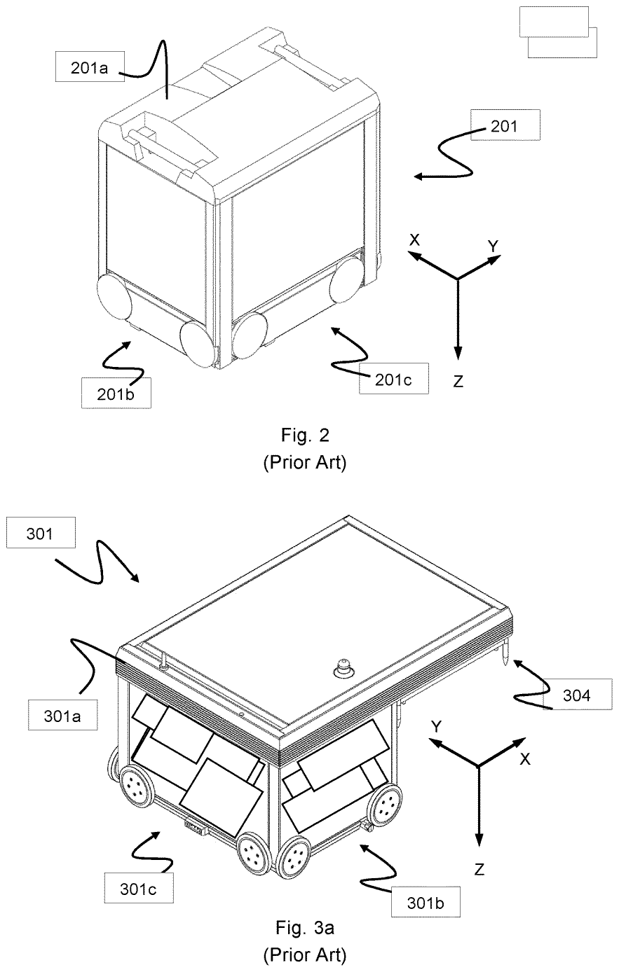

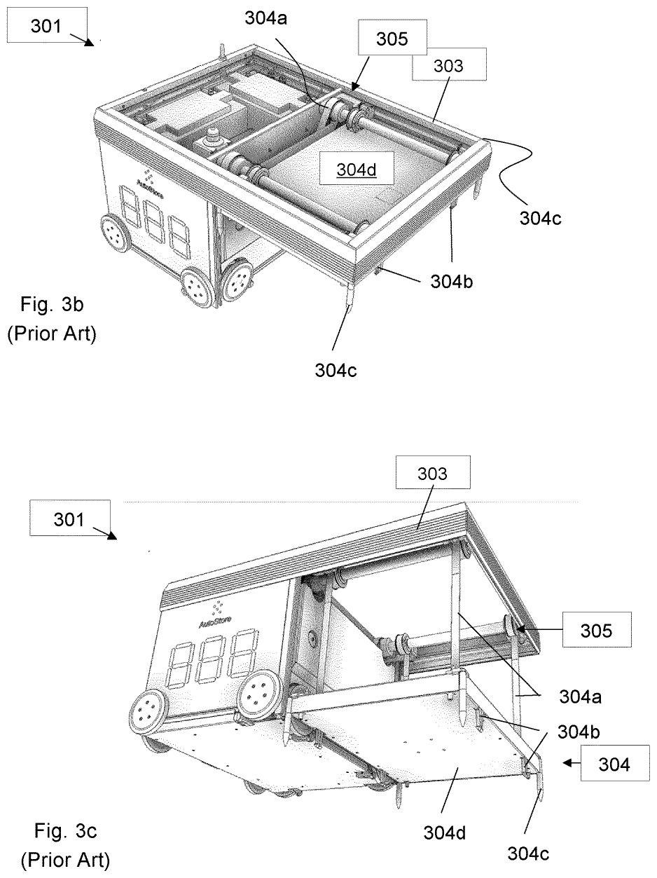

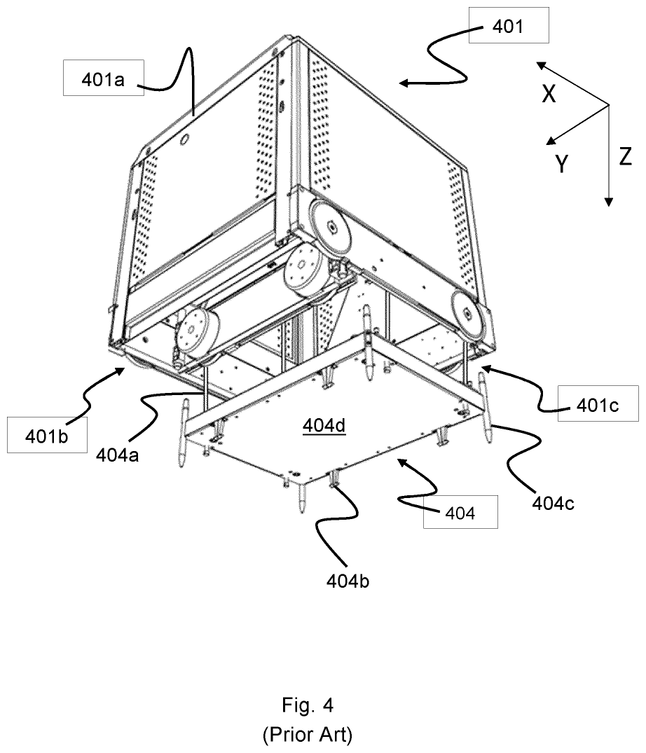

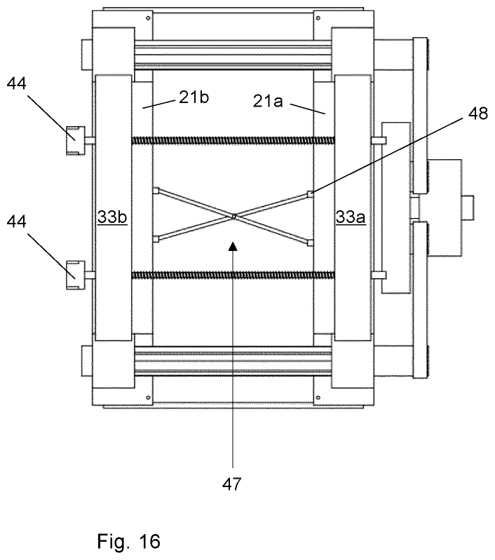

The container handling vehicle shown in FIG. 12 is of the type according to FIG. 2 or FIG. 4, i.e. where the gripper device is located within a cavity of the vehicle body, although the features described below are equally valid for other types of container handling vehicles, such as a cantilever vehicle of the type shown in FIG. 3a-3c. In FIGS. 12 to 14, a smaller-sized second storage container 6 is being gripped by the grippers 23a, 23b, while in FIGS. 15 and 16, a prior art storage container 106, larger than the second storage container 6, is being gripped by the grippers 23a, 23b.

The vehicle 10 comprises a first gripping section 20a and a second gripping section 20b, which may be identical to the first and second gripping sections described in relation to the first embodiment of the container handling vehicle 10 (ref. FIG. 8a-c and FIG. 9a-d).

In addition, the vehicle 10 comprises a first lifting section 30a for lifting the first gripping section 20a relative to the vehicle body 11 and a second lifting section 30b for lifting the second gripping section 20b relative to the vehicle body 11.

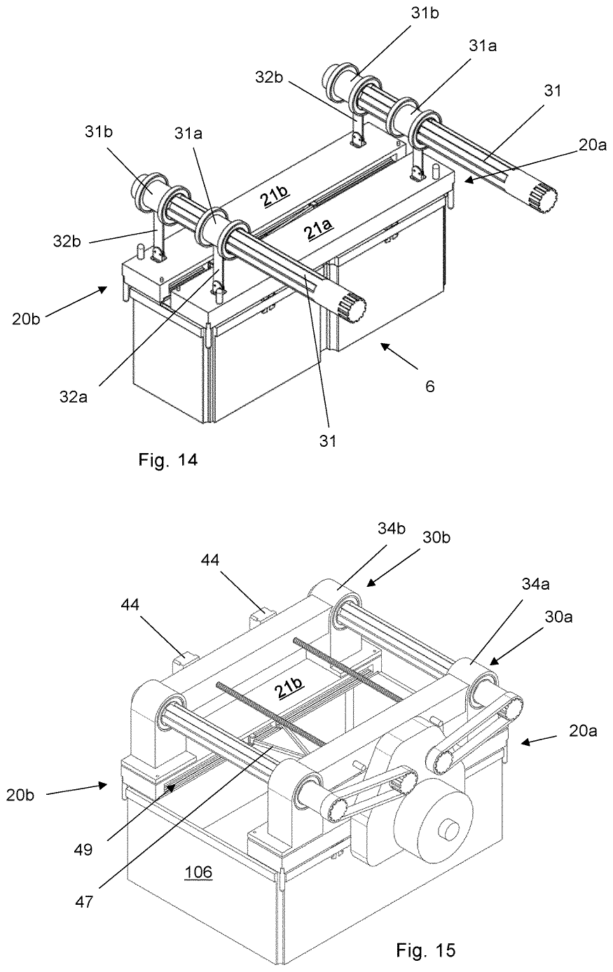

The first lifting section 30a comprises two belt drums 31a (ref. FIGS. 13 and 14), each arranged in a belt drum housing 34a at opposite ends of the first lifting section 30a, the belt drum housings 34a being rigidly connected to each other by a first connecting member 33a. The second lifting section 30b comprises two belt drums 31b, each arranged in a belt drum housing 34b at opposite ends of the second lifting section 30b, the belt drum housings 34b being rigidly connected to each other by a second connecting member 33b. The belt drums 31a and 31b may be identical or at least have the same dimensions.

The vehicle 10 comprises a first rotatable shaft 31, on which one of the belt drums 31a of the first lifting section and one of the belt drums 31b of the second lifting sections is arranged. The vehicle 10 comprises a second rotatable shaft 31, on which the other of the belt drums 31a of the first lifting section and the other of the belt drums 31b of the second lifting sections is arranged. Each belt drum 31a, 31b comprises a lifting belt 32a, 32b (ref. FIG. 14) connecting the belt drum 31a, 31b to the first or the second gripping section 20a, 20b. The rotatable shafts 31 are supported by the vehicle body 11.

By rotation of the rotatable shafts 31, the lifting belts 32a, 32b will either be reeled onto or reeled out from the belt drums 31a, 31b, causing the first and second gripping sections 20a, 20b to be lifted or lowered respectively.

In the present embodiment, the shaft is a splined shaft, allowing the belt drums 31a, 31b to be axially displaced relative to the splined shaft 31 while allowing the belt drums 31a, 31b to be rotated inside the belt drum housing 34a, 34b by the same splined shaft 31.

The rotatable shafts 31 are driven by a motor 45 (ref. FIG. 13). The same motor may be used to drive both rotatable shafts 31. This arrangement may be configured such that the rotatable shafts 31 are rotated with the same speed, thus enabling synchronized lifting, e.g. by including a proper gear arrangement to the motor 45.

The vehicle 10 here comprises two actuators. A first actuator 41 is arranged to adjust the horizontal position of the first gripping section 20a by adjusting the horizontal position of the belt drums 31a of the first lifting section 30a on the shafts 31. In this way, the first actuator 41 is adjusting the horizontal position of the first gripping section 20a relative to the vehicle body 11.

A second actuator 42 is arranged to adjust a horizontal position of the second gripping section 20b by adjusting the horizontal position of the belt drums 31b of the second lifting section 30b on the shafts 31. In this way, the second actuator 42 is adjusting the horizontal position of the second gripping section 20b relative to the vehicle body 11.

The first and second actuators 41, 42 are here in the form of a first and a second threaded rod, each driven by a motor 44, which may be an electromotor. The first threaded rod 41 passes through a hole in the second connecting member 33b, and further through a threaded hole in the first connecting member 33a, where the threads on the rod 41 engages the threads of the hole in the first connecting member 33a. Thus, by rotating the first threaded rod 41, the first connecting member 33a is moved in the longitudinal direction of the rod 41, thus moving the first gripping section 20a relative to the vehicle body 10. Similarly, the second threaded rod 42 passes through a threaded hole in the second connecting member 33b, where the threads on the rod 42 engages the threads in the hole, and further passes through a hole in the first connecting member 33a. Thus, by rotating the second threaded rod 42, the second connecting member 33b is moved in the longitudinal direction of the rod 42, thus moving the second gripping section 20b relative to the vehicle body 10. Since the second threaded rod 42 does not engage with any threads in the hole in the first connecting member 33a, the first connecting member 33a is not moved when the threaded rod 42 is rotated, such that when rotating the threaded rod 42, the second gripping section 20b is also moved relative to the first gripping section 20a.

The vehicle 10 may comprise a spacer device for adjusting and maintaining the horizontal distance between the frame 21a of the first gripping section 20a and the frame 21b of the second gripping section 20b. This spacer device may be a third actuator 43, as described in relation to the first embodiment of the vehicle 10. An alternative device is shown in FIGS. 15 and 16.

FIG. 15 illustrates schematically the container handling vehicle according to FIG. 12, where the grippers 23a, 23b are holding a larger prior art storage container 106. The vehicle body is removed to better show the lifting sections 30a, 30b and gripping sections 20a, 20b. FIG. 15 also shows an adjustable spacer 47 connecting the frame 21a of the first gripping section 20a with the frame 21b of the second gripping section 20b. The adjustable spacer 47 allows for adjusting a horizontal position of the frame 21b of the second gripping section 20b relative to the frame 21a of the first gripping section 21a. However, this is only allowed when the frames 21a, 21b are in the uppermost position, i.e. the lifting belts are reeled completely onto the belt drums 31a, 31b. When the frames 21a, 21b are lowered from this position, the adjustable spacer 47 is locked, so that the distance between the frames 21a, 21b is maintained.

The adjustable spacer 47 is also shown in FIG. 16, which gives a top view of the embodiment of FIG. 15. Here it is seen that the spacer 47 comprises to crossing arms. Each end of the arms comprises a gliding member 48, which is arranged to glide sideways in a guide 49 on the frame 21a, 21b, such that the arms of the spacer 47 may be moved towards or away from each other, thereby adjusting the distance between the frames 21a, 21b. The adjustable spacer 47 is configured to be in a locked state where the gliding members 48 are prevented from moving within the guide 49, and in an unlocked state where the gliding members 48 are released and allowed to move. For this purpose, the frames 21a, 21b may for example comprise a spring-loaded member configured to interfere with the vehicle body 11 when the frames 21a, 21b are in the upper most position, such that the spring loaded member is forced out of position, thus releasing the gliding members 48. When the distance between the first and second gripping sections 20a, 20b is to be adjusted, the first and/or second actuator 41, 42, may be used. The gliding members 48 will then move sideways in the guide to adjust the distance between the frames 21a, 21b accordingly. Once the gripping sections 20a, 20b are moved away from the uppermost position, the gliding members 48 are prevented from moving and the horizontal distance between the frames 21a, 21b of the first and second gripping sections 20a, 20b is therefore maintained. Thus, a third actuator is not necessary.

### Alternative Embodiments

It should be noted that in the embodiments described above, the separation wall 2 may serve the same purpose as the upright members 102, i.e. to guide a gripper device of a container handling vehicle during movement down into and up from the second storage columns 105A, 105B and to guide a second storage container during its movement down into and up from the second columns 105A, 105B.

It should be noted that in the embodiments described above, the container handling vehicle comprises a control system 50 for controlling the first actuator 41, the second actuator 42 and/or the third actuator 43 to keep the distance between the position of the first gripping section 20a and the position of the second gripping section 20b proportional to the distance between the belt drum 31a of the first lifting section 30a and the belt drum 31b of the second lifting section 30a. The control system may control the motors 44 of the first, second and third actuators.

The control system 50 may control lifting and lowering of the first and second gripping sections, e.g. by controlling the motor 45 that drives the rotatable shafts 31. Thus, the control system 50 may keep the first gripping section 20a and the second gripping section 20b horizontally aligned with each other.

In an alternative embodiment, the belt drum 31a is provided on a separate shaft than the belt drum 31b.

In the preceding description, various aspects of the container handling vehicle and the automated storage and retrieval system according to the invention have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention.

### LIST OF REFERENCE NUMBERS

1 retrieval system
2 separation element
6 smaller-sized second storage container
6e1 first edge
6e2 second edges
10 container handling vehicle
11 vehicle body
11a cantilever structure
20a first gripping section
20b second gripping section
21a frame
21b frame
22a least two guide pins
22b least two guide pins
23a gripper
23b gripper
30a first lifting section
30b second lifting section
31 rotatable shaft
31a belt drum
31b belt drum
32a lifting belt p1 32b lifting belt
33a connecting member
33b connecting member
34a belt drum housing
34b belt drum housing
41 first actuator
42 second actuator
43 third actuator
44 motor
45 motor
47 adjustable spacer
48 gliding member
50 control system
100 Framework structure
102 Upright members of framework structure
104 Storage grid
105 Storage column
105A, 105B second, smaller-sized storage column
106e1 first edge
106e2 second edge
107A, 107B second stacks
106 Storage container
106′Particular position of storage container
107 Stack
108 Rail system
110 Parallel rails in first direction (X)
112 Access opening
119 First port column
120 Second port column
201 Prior art container handling vehicle
201a Vehicle body of the container handling vehicle 201
201b Drive means/wheel arrangement/first set of wheels in first direction (X)
201c Drive means/wheel arrangement/second set of wheels in second direction (Y)
301 Prior art cantilever container handling vehicle 301a Vehicle body of the container handling vehicle 301 301b Drive means/first set of wheels in first direction (X) 301c Drive means/second set of wheels in second direction (Y)
304 Gripper device
401 Prior art container handling vehicle
401a Vehicle body of the container handling vehicle 401
401b Drive means/first set of wheels in first direction (X)
401c Drive means/second set of wheels in second direction (Y)
404 Gripper device
404a Lifting band
404b Gripper
404c Guide pin
404d Lifting frame
500 Control system
X First direction
Y Second direction
Z Third direction
D2 second distance
D3 third distance
FL floor
GI gripper interface
GPI guide pin interface
L106 length
L6 length

1-18. (canceled)

19. A container handling vehicle for an automated storage and retrieval system, wherein the container handling vehicle comprises:
a vehicle body;
a first gripping section for engaging a first edge of a storage container;
a first lifting section for lifting the first gripping section relative to the vehicle body;
a second gripping section for engaging a second edge of the storage container;
a second lifting section for lifting the second gripping section relative to the vehicle body;
wherein the first lifting section and the second lifting section are configured to keep the first gripping section and the second gripping section horizontally aligned with each other; and
a first actuator for adjusting a horizontal position of the first gripping section and/or the second gripping section relative to the vehicle body.

20. The container handling vehicle according to claim 19, wherein the first gripping section and the second gripping section are secured to each other, and wherein the first actuator is arranged to adjust a horizontal position of the first gripping section and the second gripping section.

21. The container handling vehicle according to claim 19, wherein the container handling vehicle comprises:
a second actuator for adjusting a horizontal position of the second gripping section relative to the first gripping section.

22. The container handling vehicle according to claim 21, wherein the container handling vehicle is configured to be in one of the following states:
a first state, in which the position of the first gripping section is a first distance from the position of the second gripping section for the purpose of engaging a first storage container;
a second state, in which the position of the first gripping section is a second distance from the position of the second gripping section for the purpose of engaging a second storage container, wherein the second distance is smaller than the first distance.

23. The container handling vehicle according to claim 22, wherein the second distance is 40%-50% of the first distance.

24. The container handling vehicle according to claim 22, wherein the first actuator and the second actuator are configured to move the second storage container horizontally relative to the vehicle body when in the second state.

25. The container handling vehicle according to claim 24, wherein the first actuator and the second actuator are configured to move the second storage container a third distance being equal to, or larger than, the second distance relative to the vehicle body when in the second state.

26. The container handling vehicle according to claim 22, wherein the first gripping section is configured to engage a first edge of the first storage container and a first edge of the second storage container and wherein the second gripping section is configured to engage a second edge of the first storage container and a second edge of the second storage container.

27. The container handling vehicle according to claim 22, wherein the first storage container has a width being equal to a width of the second storage container and a length being equal to or less than 50% of a length of the second storage container.

28. The container handling vehicle according to claim 19, wherein:
the container handling vehicle comprises a rotatable shaft;
the first lifting section comprising a belt drum connected to the rotatable shaft and a lifting belt connected between the belt drum and the first gripping section;
the second lifting section comprising a belt drum connected to the rotatable shaft or a further shaft and a lifting belt connected between the belt drum and the second gripping section;
wherein the first actuator is arranged to adjust the horizontal position of the first gripping section by adjusting the horizontal position of the belt drum of the first lifting section on the rotatable shaft.

29. £ (New) The container handling vehicle according to claim 28, wherein the second actuator is arranged to adjust the horizontal position of the second gripping section relative to the first gripping section by adjusting a horizontal position of the belt drum of the second lifting section relative to the belt drum of the first lifting section on the shaft or on the further shaft.

30. The container handling vehicle according to claim 29, wherein:
the first gripping section comprises a frame, at least two guide pins secured to the frame and a gripper secured to the frame;
the second gripping section comprises a frame, at least two guide pins secured to the frame and a gripper secured to the frame;
the container handling vehicle comprises a third actuator for adjusting a horizontal distance between the frame of the first gripping section and the frame of the second gripping section.

31. The container handling vehicle according to claim 30, wherein the container handling vehicle comprises a control system for controlling the first actuator, the second actuator and/or the third actuator.

32. The container handling vehicle according to claim 31, wherein the control system is configured to control the first actuator, the second actuator and the third actuator to keep a distance between the position of the first gripping section and the position of the second gripping section proportional to the distance between the belt drum of the first lifting section and the belt drum of the second lifting section.

33. An automated storage and retrieval system comprising a framework structure, wherein the framework structure comprises:
upright members;
a first storage volume comprising first storage columns provided between the upright members, wherein first storage containers are stackable in first stacks within the first storage columns;
a second storage volume comprising second storage columns provided between the upright members, wherein second storage containers are stackable in second stacks within the second storage columns; and
a rail system provided on top of the upright members, wherein the automated storage and retrieval system comprises a container handling vehicle arranged to operate on the rail system;
characterized in that the container handling vehicle is a container handling vehicle according to claim 19, wherein the container handling vehicle is configured to handle the second storage containers.

34. The automated storage and retrieval system according to claim 33, wherein the second storage columns are formed by separating one of the first storage columns into two or more storage columns.

35. The automated storage and retrieval system according to claim 34, wherein the framework structure comprises a separation element for separating the first storage columns into two or more second storage columns.

36. The automated storage and retrieval system according to claim 35, wherein the container handling vehicle is arranged to handle the first storage containers and the second storage containers by adjusting the horizontal position of the second gripping section relative to the first gripping section.
